(19) United States
(12) Patent Application Publication
(10) Pub. No.: US 2014/0207533 A1
(43) Pub. Date: Jul. 24, 2014

(54) METHOD FOR RECORDING AND TRACKING THE PROGRESS OF SALES ACTIVITIES

(71) Applicant: Stephen Pavne Gregg, Lake Forest, CA (US)

(72) Inventor: Stephen Pavne Gregg, Lake Forest, CA (US)

(21) Appl. No.: 13/748,785

(22) Filed: Jan. 24, 2013

(51) Int. Cl. G06Q 10/06

(52) U.S. Cl. CPC G06Q 10/06398
USPC 705/7.42

(57) ABSTRACT

The method teaches and enable the tracking of the number of new prospects, the number of phone calls made, the number of phone invites made, the number in-person invites made, number of email invites, the number of appointments made, the number of confirmations, the number of prospects who attended appointments, the number of second meetings scheduled and held, and the number of new customers or distributors acquired. The orders of activities tracked is the same as those listed, and is displayed on a computer screen or in paper in that specific order for each day of the week, with goals and total columns to track a user's actions and success. A second area tracks telephone calls made and use a three legend key to track the number of calls made (represented by a slash) and the number of appointments set during calls (represented by an encircled slash).

### FEDERALLY SPONSORED RESEARCH

Not Applicable

### SEQUENCE LISTING OR PROGRAM

Not Applicable

### CROSS REFERENCE TO RELATED APPLICATIONS

This application claims priority from U.S. Patent Application Ser. No. 61/590,964, entitled “METHOD FOR RECORDING AND TRACKING THE PROGRESS OF SALES ACTIVITIES”, filed on Jan. 26, 2012. The benefit under 35 USC §119(e) of the United States provisional application is hereby claimed, and the aforementioned application is hereby incorporated herein by reference.

### TECHNICAL FIELD OF THE INVENTION

This invention relates generally to methods for recording priorities for activities to be undertaken and for keeping track of the progress of sales activities. More specifically, the present invention relates to a method for providing a chart for listing such activities which contains a calendar upon which such activities can be targeted for goals and the amount of activities performed tracked. Symbols can be applied to a call tracking chart for tracking and evaluating calling activity.

### BACKGROUND OF THE INVENTION

Charts and systems containing calendars have been used in the prior art to practice well known methods for the management of time in the planning for the undertaking of sales activities, tasks, and projects of all kinds The most successful sales representatives look at charts, calendar systems, and sales reports as tools to monitor if they are on course to reach their goals. These sales representatives know that by tracking their activities, they can ensure they are completing the necessary daily tasks that will make them successful. They also know that activity tracking can determine areas for improvement so they can be even more successful in the future.

What is needed at this time is a method for recording and tracking the progress of sales activities that enables a user to know exactly where they stand, enables them to quickly calculate their success ratios.

### SUMMARY OF THE INVENTION

The present invention is a method for tracking daily activities that lead to sales. The key components of the process are what is tracked on the Daily Activity Tracker (DAT), the order of what is tracked, and the method of what is tracked, in addition to Goals: M-Sun—Totals: over under.

The method teaches and enable the tracking of the number of new prospects, the number of phone calls made, the number of phone invites made, the number in-person invites made, the number of appointments made, the number of confirmations, the number of prospects who attended appointments, the number of second meetings scheduled and held, and the number of new customers or distributors acquired.

The orders of activities tracked is the same as those listed, and is displayed on a computer screen or in paper in that specific order for each day of the week, with goals and total columns to track a user's actions and success. A second area tracks telephone calls made and use a three legend key to track the number of calls made (represented by a slash) and the number of appointments set during calls (represented by an encircled slash).

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a plan view of a sheet containing a table and telephone call grid which can be provided and used in accordance with the steps of the activities management method of the present invention;

FIG. 2 shows a screen captures of a webpage containing a weekly table which can be provided and used in accordance with the steps of the activities management method of the present invention;

FIG. 3 shows a screen captures of a webpage containing a monthly table which can be provided and used in accordance with the steps of the activities management method of the present invention;

FIG. 4 shows a screen captures of a webpage containing a quarterly table which can be provided and used in accordance with the steps of the activities management method of the present invention;

FIG. 5 shows a screen captures of a webpage containing a semi-annual table which can be provided and used in accordance with the steps of the activities management method of the present invention;

FIG. 6 shows a screen captures of a webpage containing a team report for tope performs for a weekly period which can be provided and used in accordance with the steps of the activities management method of the present invention; and

FIG. 7 shows a screen captures of a webpage containing a total sale team report which can be provided and used in accordance with the steps of the activities management method of the present invention;

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

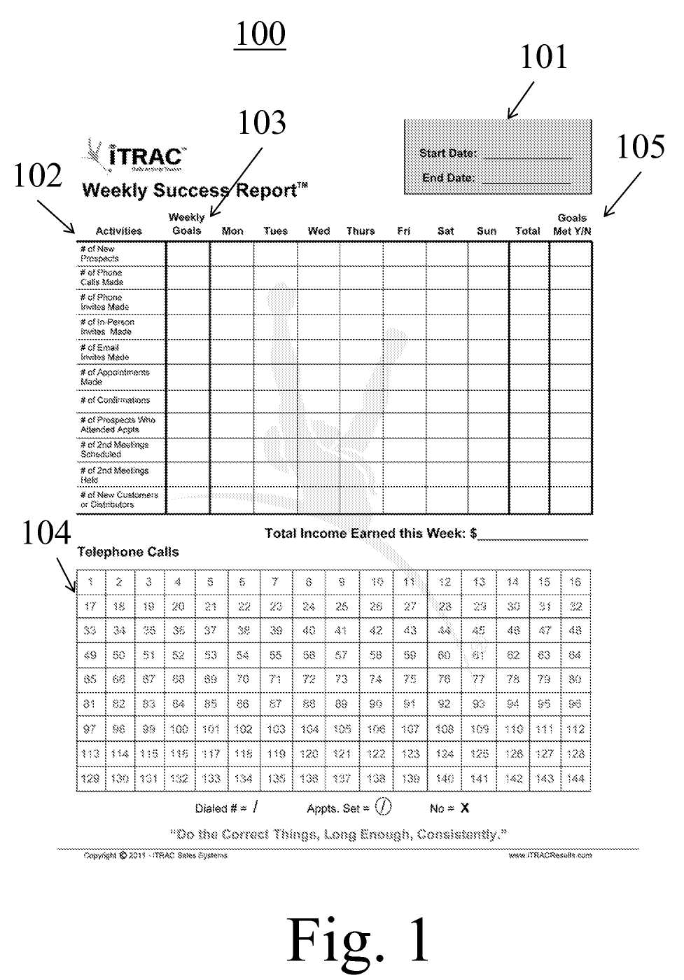

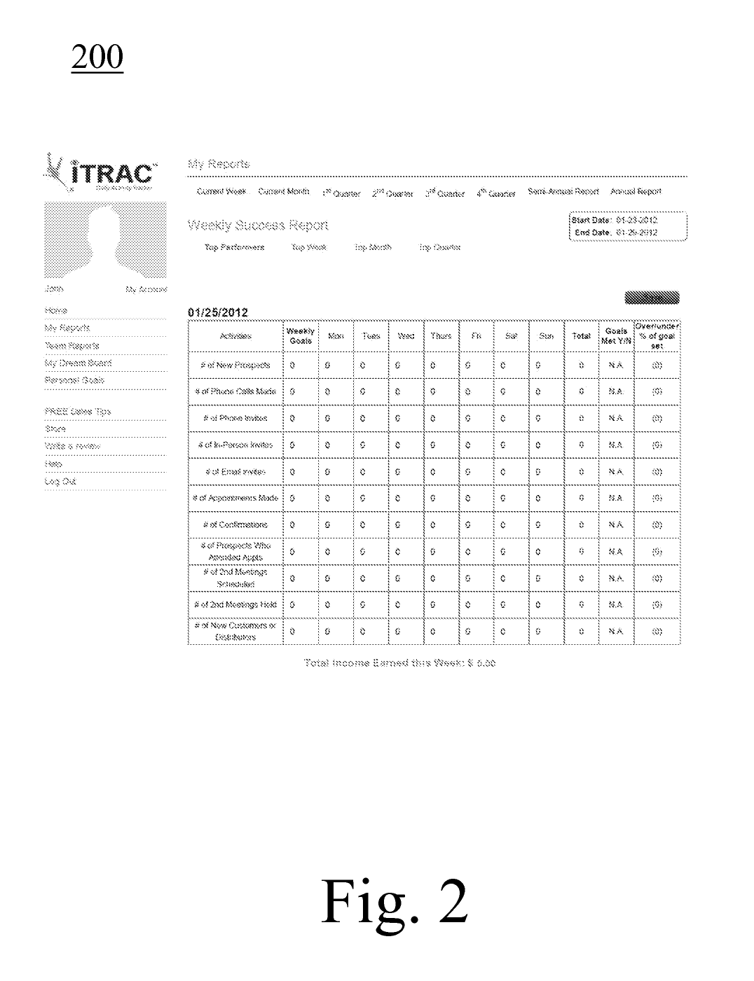

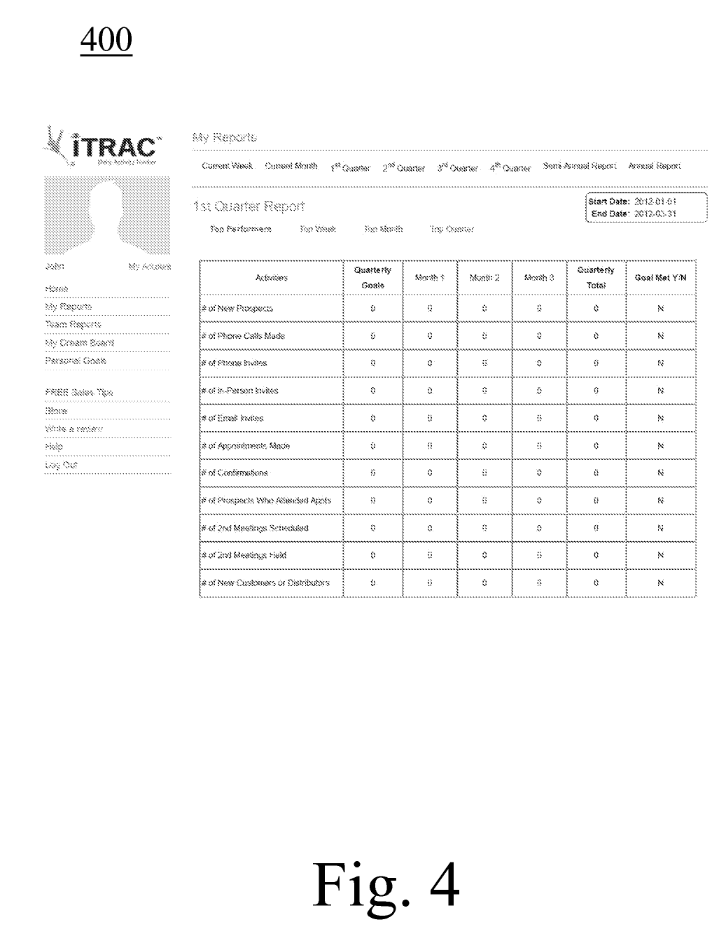

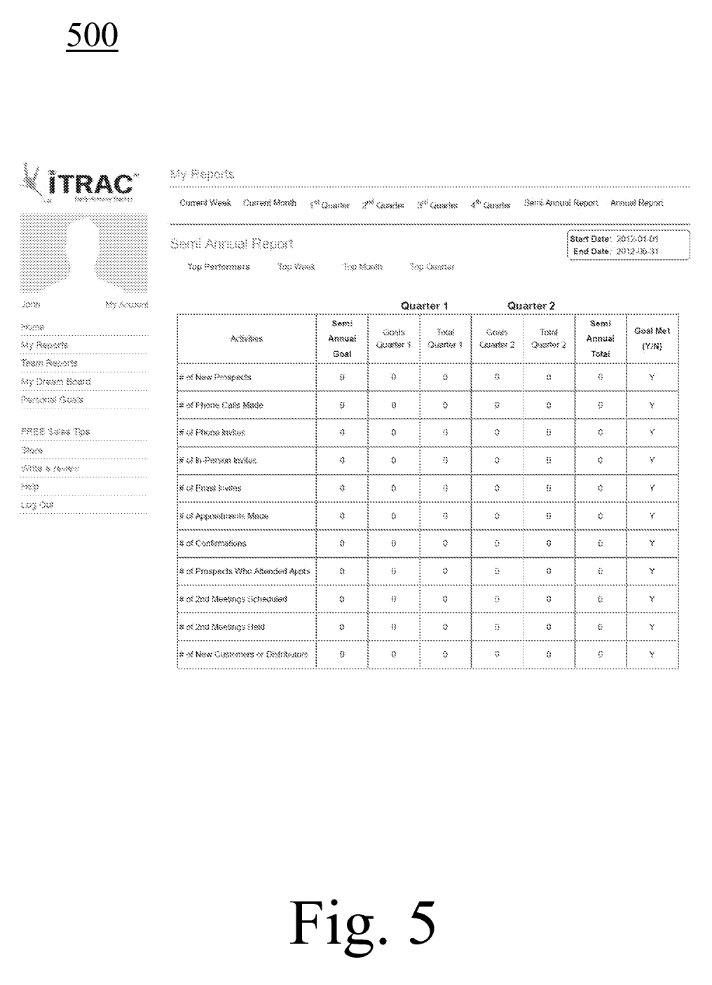

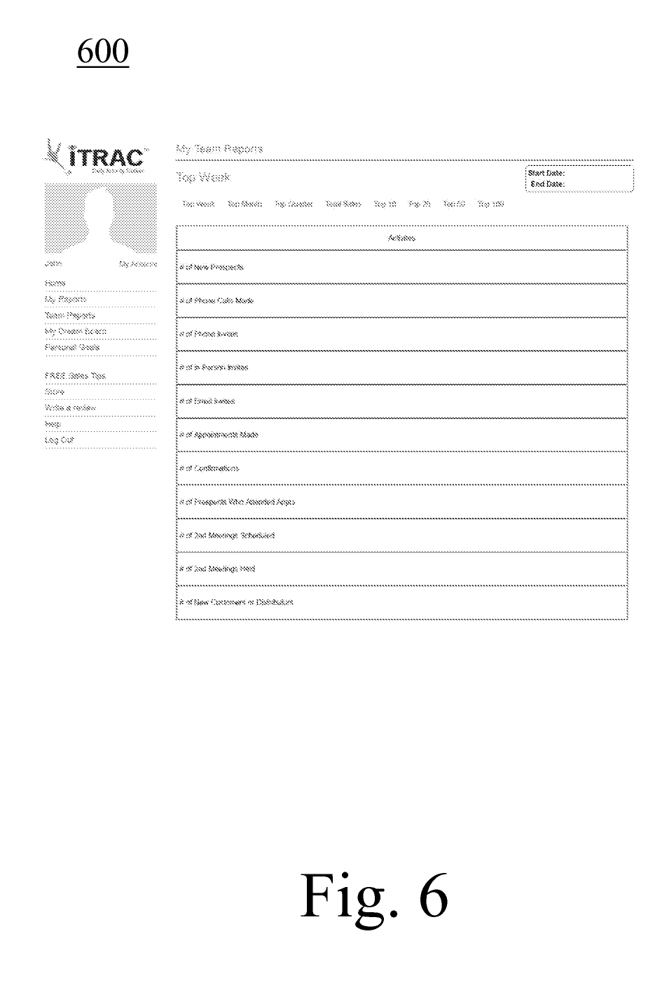

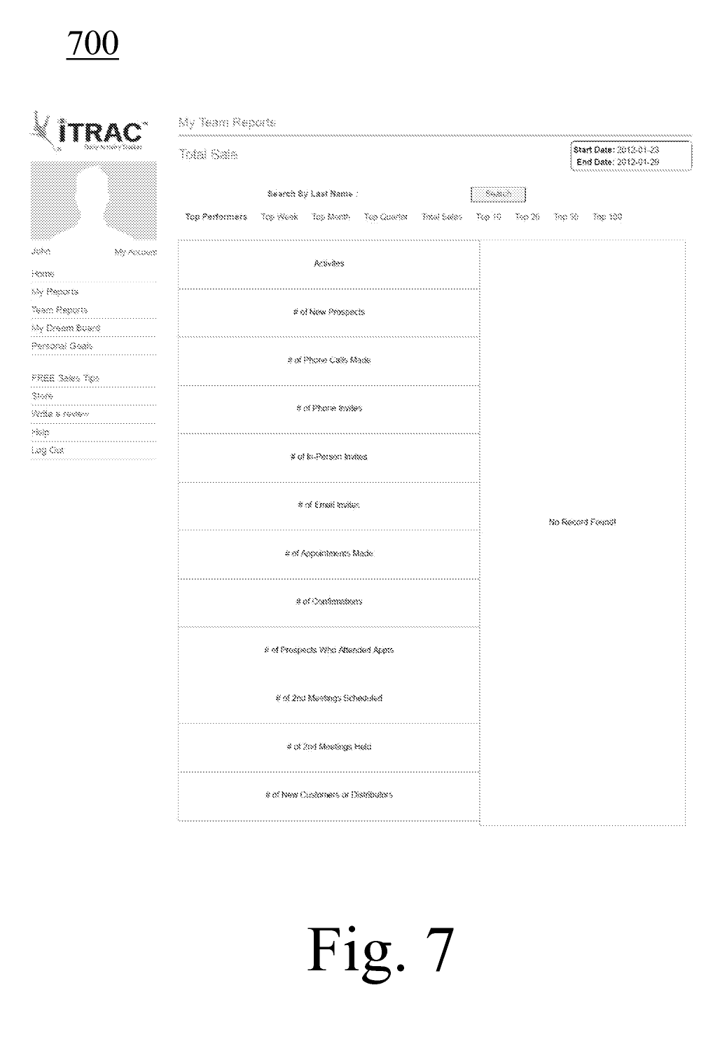

Now referring to the Figures, the embodiment of the method for the recording and tracking the progress of sales activity is shown. Now referring to FIG. 1, the present invention is a tracking means for sales that is a booklet with a plurality of tracking pages 100 in one embodiment. In an alternative embodiment, the present invention is used in electronic form so that all information can be entered through an electronic computer interface 200 communicating with a server to track and store information as shown in FIGS. 2-5. This enables one or more managers, and individual users to access, store, and track their individual or team performance 600 and 700 as shown by FIGS. 6-7.

The Daily Activity Tracker (DAT) tracks the most important part of the sales process, that being the activity that tracks the sales. Each page 100 of the Daily Activity Tracker (DAT) tracks one week of activity. It is recommended that each week start on a Monday and end on a Sunday for uniformity and consistency. The start and end date for the week is first entered on the top of the page 101. First a list of activities 102 is determined by the user based on their specific situation. Next weekly goals 103 are entered in the left hand columns for each activity. Weekly goals 103 are the goals that the user intends on reaching each week for the corresponding activity, they are not wishes. These are attainable, believable, and realistic goals based on the user's individual schedule but challenging enough so that the user must stretch to reach them.

The weekly goals 103 and activities 102 on the left hand columns typically include recording of the following activities and corresponding weekly goal numbers: number of new prospects, number of phone calls made, number of phone invites, number of email invites, number of in-person invites, number of appointments made, number of confirmations, number of prospects who attended appointments, number of second meetings scheduled, number of second meetings held, and number of new customers or distributors.

A user should always have a plan for meeting new prospects. New prospects are not people that the user already has their name or number. A prospect is someone who the user has spoken to or communicated with in some manner that has enquired about or shown interest in the product or service being sold. The user should decide on the number of prospects they want to reach and place that number in the weekly goals box associated with the number of new prospects line.

The user then repeats this process by deciding on a number goals for each weekly goal corresponding to the activity 102 listed on activity line and places that number in the box corresponding to the weekly goal 103 or activity line for the corresponding activity 102. A user will adjust the number of weekly goals 103 or activities 102 for their specific situation.

A user must decide on how many times they will call prospects or new leads. A telephone call grid 104 is located on the bottom of the form and has three functions. The three recording functions are: a slash, which means the user dialed the phone; a zero, which means the user called the person and made an appoint to explain or pitch their opportunity to them; and an x, which means the user spoke to the person and they have no interest in the opportunity, product, or services, the user is presenting. Using the call grid 104 allows the individual, manager, or team to track and determine how effective the user is on the phone.

At the end of day, the user will total up the number of activities they completed and fill in the corresponding box for the day of the week and the weekly goal/activity, with that number. Each day the form is filled out complete providing accountability to the user for their success or failure. At the end of each week the user will put the totals for each week in the totals column 105 located at the right hand side of the grid. The user will then evaluate whether they met their goals and place a “Y” for yes or an “N” for no in the goal met column 104 for each weekly goal 103 or activity 102. The under then calculates and over/under percentage for each individual weekly goal 103 or activity 102 with respect to their performance for the week in achieving the weekly goals 103 for the activities 102. This tracking sheet 100, has now transformed into an activity summary showing the user exactly how much and what work was performed for the time period being measured. The tracked results 103 or activities 102, provides the user with an understanding why they are succeeding or failing in their activities.

The next steps in the process are the in-step process and white boxing techniques. The in-step process provides a priority list of what the user needs to get done and the order in which it needs to be done.

At the end of months, quarters, years, or any specified time period, the user can conduct a self-analysis of their activity and productivity by totaling their activity, goals, actions, and percentages. This provides a user with an objective look at their business and identifies what actions are making them successful or causing them to fail. Additionally, the tracked results show the user which activities they are strong at and which activities are their weakest. For example, if the user set a prospects goal of 20, but the Daily Activity Tracker report 101 shows they only contacted 10 prospects, they can ask themselves if they really worked this week or put in the time and effort to reach their goal, or possibly review their goal to see if it is too high, unattainable, or if they have the resources available to them to reach the goal or if they additional resources or skills to reach the goal that has been set.

By reviewing the telephone call grid 104, a user can easily see if they reached their set goal for number of calls if the goals was not reached, identify what activities took place that week which caused them to fail to meet that goal. Alternatively, if the call grid 104 shows they receive a lot of no's, then it could assist them in determining that their phone skills need more work, they are contacting the wrong people, or there is an issue with their phone script or sales technique. If a user was calling at the wrong time of the day, this would be shown by an overwhelming number of slashes “/” where no one was available to answer the phone to provide a yes or no answer to the sales pitch. Using the telephone call grid 104 a user can accurately see what is going on in their business.

Invitations are different for every business. Invitations can be a phone call, conference call, webinar, physical meeting on person or the phone. The Invitations section of the tracking grid allows user to see how many people they are inviting to see their products or services. The more people invited, the more opportunity to present the product or service. In most situations there is a need for a second meeting before a sale is made. It is the natural progression of the sale, and a lot of sales people forget or overlook this step. The system suggests that the purpose of a meeting is to book another meeting or make a sale. This is why it is recommended that a user track the number of second meetings.

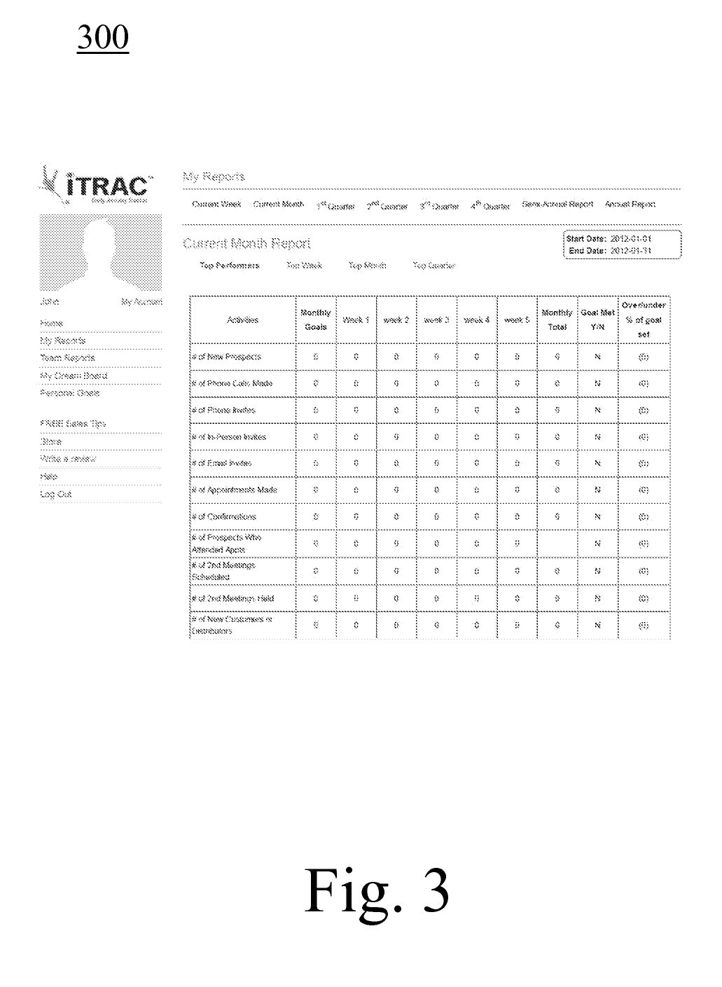

Now referring to FIGS. 3-7, at the end of months 300, quarters 400, semi-annual 500 or yearly 600, or any specified time period, the team manager can conduct a self-analysis of their team's activity and productivity by totaling the activity, goals, actions, and percentages of individuals and the team as a whole. This provides a team manager with an objective look at their team members and identifies what actions are making them successful or causing them to fail, at what level each team member is performing at individually and compared to other team members, as well as identifying team and individual team member strengths and weaknesses.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. A method for indicating selected dates for the commencement of specific activities and for documenting the status of the activities, the steps of which comprise:
providing at least one table for itemizing a series of specific activities to be undertaken;
providing separate rows of a first column for establishing a selected number of activities;
providing separate rows of a second column adjacent to the first column for establish goals for corresponding adjacent activity columns;
providing separate columns adjacent to the second column establishing a selected number of successive dates representing a selected portion of a calendar year during which said activities are to be undertaken, said successive dates being represented by successive columns and rows adjacent to the activity and goal columns to form the table;
providing a calling grid located below the table;
the calling grid comprised of a plurality of numbered blocks;
the numbered blocks corresponding to calling activity; and
providing a plurality of symbols representing no answer to a phone call, a favorable phone call or a negative phone call.

2. The method of claim 1, wherein
the table is provided on paper that is a booklet with a plurality of tracking pages.

3. The method of claim 1, wherein
the table is provided by a computer used in electronic form so that all information can be entered through an electronic interface communicating with a server to track and store information.

4. The method of claim 3, wherein
one or more managers, and individual users to access, store, and track their individual or team performance.

5. The method of claim 1, wherein
the Daily Activity Tracker (DAT) tracks the most important part of the sales process, that being the activity that tracks the sales;
each page of the Daily Activity Tracker (DAT) tracks one week of activity;
each week starts on a Monday and ends on a Sunday for uniformity and consistency; and
the start and end date for the week is first entered on the top of the page.

6. The method of claim 5, further comprising the steps of
a list of activities is determined by the user based on their specific situation;
entering weekly goals in the left hand columns for each activity; and
weekly goals are the goals that the user intends on reaching each week for the corresponding activity.

7. The method of claim 6, wherein
the weekly goals and activities on the left hand columns include recording one or more of the following activities and corresponding weekly goal numbers: number of new prospects, number of phone calls made, number of phone invites, number of email invites, number of in-person invites, number of appointments made, number of confirmations, number of prospects who attended appointments, number of second meetings scheduled, number of second meetings held, and number of new customers or distributors.

8. The method of claim 1, wherein
a prospect is someone who the user has spoken to or communicated with in some manner that has enquired about or shown interest in the product or service being sold; and
a decision on the number of prospects they want to reach and place that number in the weekly goals box associated with the number of new prospects line.

9. The method of claim 8, further comprising the steps of
repeating this process by deciding on a number goal for each weekly goal corresponding to the activity listed on activity line and places that number in the box corresponding to the weekly goal or activity line for the corresponding activity; and
adjusting the number of weekly goals or activities for their specific situation.

10. The method of claim 8, further comprising the steps of
deciding on how many times to call prospects or new leads;
providing a telephone call grid located on the bottom of the form and has three functions;
a slash means the user dialed the phone; a zero means the user called the person and made an appoint to explain or pitch their opportunity to them;
an x means the user spoke to the person and they have no interest in the opportunity, product, or services, the user is presenting; and
using the call grid allows the individual, manager, or team to track and determine how effective the user is on the phone.

11. The method of claim 8, further comprising the steps of
totaling up the number of activities completed; and
filling in the corresponding box for the day of the week and the weekly goal/activity, with that number.

12. The method of claim 11, further comprising the steps of
filling out the form each day; and
providing accountability to the user for their success or failure.

13. The method of claim 12, further comprising the steps of
putting the totals for each week in the totals column located at the right hand side of the grid at the end of each week;
evaluating whether goals were met;
placing a “Y” for yes or an “N” for no in the goal met column for each weekly goal or activity; and
calculating the over/under percentage for each individual weekly goal or activity with respect to the performance for the week in achieving the weekly goals for the activities.

14. The method of claim 13, further comprising the steps of
providing a priority list of what needs to get done and the order in which it needs to be done.

15. The method of claim 14, further comprising the steps of
conducting a self-analysis of their activity and productivity by totaling their activity, goals, actions, and percentages;
providing an objective look at their business and identifies what actions are making them successful or causing them to fail; and
illustrating which activities are strong and which activities are weak.

16. The method of claim 14, further comprising the steps of
reviewing the telephone call grid;
determining if a set goal for number of calls if the goals was reached; and
identifying what activities took place that week which caused them to fail to meet that goal.

17. The method of claim 1, further comprising the steps of
providing an invitations section of the tracking grid allows user to see how many people they are inviting to see their products or services; and
suggesting that the purpose of a meeting is to book another meeting or make a sale.

17. The method of claim 14, further comprising the steps of
conducting a self-analysis of a team's activity and productivity at the end of any specified time period; and
totaling the activity, goals, actions, and percentages of individuals and the team as a whole.

18. A booklet with a plurality of tracking pages for indicating selected dates for the commencement of specific activities and for documenting the status of the activities, the booklet comprising:
at least one table for itemizing a series of specific activities to be undertaken;
separate rows of a first column for establishing a selected number of activates;
separate rows of a second column adjacent to the first column for establish goals for corresponding adjacent activity columns;
separate columns adjacent to the second column establishing a selected number of successive dates representing a selected portion of a calendar year during which said activities are to be undertaken, said successive dates being represented by successive columns and rows adjacent to the activity and goal columns to form the table;
a calling grid located below the table;
the calling grid comprised of a plurality of numbered blocks;
the numbered blocks corresponding to calling activity; and
a plurality of symbols representing no answer to a phone call, a favorable phone call or a negative phone call.

19. The booklet of claim 1, wherein
the Daily Activity Tracker (DAT) tracks the most important part of the sales process, that being the activity that tracks the sales;
each page of the Daily Activity Tracker (DAT) tracks one week of activity;
each week starts on a Monday and ends on a Sunday for uniformity and consistency; and
the start and end date for the week is first entered on the top of the page.

20. The method of claim 19, further comprising the steps of
a list of activities is determined by the user based on their specific situation;
entering weekly goals in the left hand columns for each activity;
weekly goals are the goals that the user intends on reaching each week for the corresponding activity; and
the weekly goals and activities on the left hand columns include recording one or more of the following activities and corresponding weekly goal numbers: number of new prospects, number of phone calls made, number of phone invites, number of email invites, number of in-person invites, number of appointments made, number of confirmations, number of prospects who attended appointments, number of second meetings scheduled, number of second meetings held, and number of new customers or distributors.
